(19) United States
(12) Patent Application Publication
(10) Pub. No.: US 2014/0044876 A1
(43) Pub. Date: Feb. 13, 2014

(54) METHOD FOR PRODUCING SMALL SIZE TITANIUM OXIDE PARTICLES

(71) Applicants: Asher Vitner, Jerusalem (IL); Matti Ben-Moshe, Reut (IL); Mubeen Baidossi, Kfar Qara (IL)

(72) Inventors: Asher Vitner, Jerusalem (IL); Matti Ben-Moshe, Reut (IL); Mubeen Baidossi, Kfar Qara (IL)

(73) Assignee: Joma International AS, Limingen (NO)

(21) Appl. No.: 13/988,477

(22) PCT Filed: Nov. 21, 2011
(86) PCT No.: PCT/IL11/00894

§ 371 Date: Jul. 1, 2013

(30) Foreign Application Priority Data
Nov. 21, 2010 (IL) 209459
Nov. 20, 2011 (IL) 216486

(51) Int. Cl. C01G 23/053

(52) U.S. Cl. CPC C01G 23/053
USPC 427/294; 423/610; 427/372.2; 427/343

(57) ABSTRACT

The present invention provides a method for the production of small-size titanium oxide particles, comprising the steps of: e) providing a solid containing titanic acid; f) contacting the solid with an acidic aqueous medium thereby forming an aqueous precursor solution at given conditions of temperature lower than 100° C., Titanium cation concentration lower than 20 wt % and higher than 0.1 wt %, pH lower than 1 and strong acid concentration higher than 2.5% and lower than 30%; g) optionally, adding one or more capping agents to the aqueous precursor solution; and h) modifying at least one of the conditions of the aqueous precursor and maintaining the aqueous precursor at the modified conditions, whereupon precipitation of a precipitate comprising small-size titanium oxide particles takes place, the modifications being selected from at least one of temperature elevation by at least 5° C. and pH elevation by at least 0.1 pH units.

### BACKGROUND

The present invention relates to a method for producing of small-size titanium oxide particles, such as nanoparticles and more particularly, to a method for producing small-size titanium oxide particles of desired particle size, particle size distribution and habit in an industrially and economically useful manner. The present invention is also related to particles produced by such method and to preparations produced by such method.

### BACKGROUND ART

Presently titanium oxides are widely used in industry for various applications: paint pigment, opacifying agent, welding rod fluxes, optical coatings, as a catalyst (for example in abetment of NOx from flow gases), ceramic finish coat, plastics elastomers, printing inks, roofing granules, glass, and in glazes.

Titanium oxides have at least four crystal forms: titanic acid, anatase, brookite, and rutile. Of these, the rutile form has the greatest density, hardness, and refractive index. Titanium oxide crystals are characterized by a variety of sizes, colors, densities, porosities, surface areas and shapes. These parameters have great impact on their use and performance. The final product properties depend on the procedures developed for precipitation and aging of the products. There is great interest in a technique for the production of titanium oxide particles with advanced properties, such as nano-crystallinity, narrow particle size distribution, preparation of metastable phases etc.

As presented in U.S. Pat. No. 6,830,742 and 6,653,356 titanium oxide is generally produced using a liquid phase method, in which titanium tetrachloride or titanyl sulfate is used as a starting material which is hydrolyzed in a hydrophilic solvent or in a vapor phase method, in which a volatile starting material such as titanium tetrachloride is vaporized, and then reacted in the gas state with an oxidizing gas such as oxygen or steam, at a high temperature.

In general, the titanium oxide powder produced by the liquid or vapor phase method disadvantageously undergoes heavy aggregation and a wide range of particle size distribution. In the case of titanium oxide produced by the vapor phase method, the same problems that are occurring through production via the liquid phase method, are occurring. That is, although ultra fine particulates of titanium oxide may be obtained through the conventional vapor phase method, only particulates of titanium oxide that have undergone grain growth can be obtained. Therefore, there is great interest in a technique for the production of titanium oxide materials with advanced properties, such as nano-crystallinity, narrow particle size distribution, preparation of meta-stable phases etc. In addition, many of the liquid-phase methods consume base in the hydrolysis step and generate salt product of low or negative value.

Production of nano anatase in aqueous acidic solutions is usually done in acidic solution comprising sulfate. Sulfate is known to induce aggregation thus leading to the production of large aggregates. On the other hand, titania produced from titanyl chloride aqueous solution yields nano titania of desired aggregation properties, but produces mainly rutile or a mixture comprising rutile and anatase, but rarely mostly or solely anatase.

The present invention provides in a preferred embodiment a method for the production of titania from titanyl chloride solution to produce nano anatase of low aggregation level.

The main objective of the present invention is to provide an industrial and economical method for the production of titanium oxide particles characterized by a desired particle size, size distribution and crystal habit

Another object of the present invention is to provide an industrial and economical method for the production of nano titanium oxide particles of desired size of crystals and aggregates, porosity and by the required morphology and habit.

Still another objective of the present invention is to provide an industrial and economical method for the production of nano titanium oxide particles with minimal or no consumption of a base and/or formation of co-product salt.

### DESCRIPTION

The present invention provides a method for the production of small-size titanium oxide particles, comprising the steps of: (a) providing a solid, containing titanic acid; (b) contacting said solid with an acidic aqueous medium thereby forming an aqueous precursor solution at given conditions of temperature lower than 100° C., Titanium cation concentration lower than 20 wt % and higher than 0.1 wt %, pH lower than 1 and acid concentration higher than 2.5% and lower than 30%; (c) optionally, adding one or more capping agents to the aqueous precursor solutions; and (d) modifying at least one of said conditions of said aqueous precursor and maintaining said aqueous precursor at said modified conditions, whereupon precipitation of a precipitate comprising small-size titanium oxide particles takes place said modifications being selected from at least one of temperature elevation by at least 5° C. and pH elevation by at least 0.1 pH units.

As used herein, the term small-size particles is intended to denote particles of size smaller than 200 nm, preferably smaller than 80 as determined in SEM (electronic microscopy). According to an embodiment, said particles comprise crystals of titanium dioxide. As used herein, the size of titanium dioxide crystals is the size of titanium oxide primary crystals. According to an embodiment, the size of the titanium oxide crystals in the produced small-size titanium oxide particles is in the range between 4 nm and 60. According to an embodiment, the size of the titanium oxide crystals is determined by X ray diffraction analysis.

The method of the present invention comprises providing a solid containing titanic acid. As used herein, titanic acid is the precipitate formed by mixing a base with a titanium-containing salt solution.

According to an embodiment the titanium containing salt solution is a titanyl salt. In another embodiment, the salt is a titanium salt. In a preferred embodiment the anion of said titanium or titanyl salt is an anion of a mineral salt, preferably a strong acid as an halogen, sulfate, nitrate. In a preferred embodiment, the anion is a strong organic acid such as an organic sulfunic anion.

According to an embodiment the titanium containing salt solution is the mother liquor obtained from the production of nano titanium oxide.

According to an embodiment the titanic acid is obtained by changing the conditions in a titanyl or titanium salt solution. In a preferred embodiment, the temperature during the change in condition step is lower than 120° C. In a more preferred embodiment, the temperature during the change in conditions is lower than 100° C. and in more preferred embodiment, the temperature during the change in conditions is lower than 80° C.

According to an embodiment the base is soluble in water in another preferred the base is insoluble in water thus extracting the acid from the titanium containing solution. in another preferred the base is a solid anion exchanger. In a preferred the base is added to a titanium/titanyl containing solution. In another preferred embodiment the titanium/titanyl containing solution is added into the base solution.

In a preferred embodiment the concentrations of the base and/or of the titanium/titanyl solution is higher than 0.25M. In another preferred embodiment the above concentrations are higher than 1M.

The method of the present invention comprises contacting said solid with an acidic aqueous medium thereby forming an aqueous precursor solution at given conditions of temperature, pH and concentration. According to an embodiment, said acidic aqueous medium comprises at least one of a titanium salt, a titanyl salt and an acid having a pKa lower than 1. As used herein, the term titanium salt means a molecule containing titanium cation and lacks oxygen. As used herein, the term titanyl salt means a molecule containing the TiO moiety. As used herein “acidic aqueous medium comprising a given component” is intended to denote, according to one option, that said acidic aqueous medium was formed, directly or indirectly, from said component, for example by dissolving said component in water or in an aqueous solution. According to another option, this term means that the composition is such that could be formed from said component.

According to an embodiment, said acidic aqueous medium comprises an acid selected from the group consisting of sulfuric acid, hydrochloric acid, other halogenic acids, nitric acid, organic acids of pKa lower than 1 and combinations thereof. According to an embodiment, said acidic aqueous medium comprises an organic acids of pKa lower than 1 and said organic acid is selected from the group consisting of aliphatic cyclic acids and aromatic sulfonic acids.

According to an embodiment, said acidic aqueous medium comprises at least one of titanyl chloride, titanyl sulfate, titanium chloride, titanium salts of organic acids and titanyl salts of organic acids.

According to an embodiment, said acidic aqueous medium comprises at least one additional component in addition to titanium salt, a titanyl salt and an acid. According to a related embodiment, said additional compound is selected from the group consisting of TiOx(OH)_{Y} wherein (x+y) is smaller or equal 3.

According to an embodiment, during contacting said solid with an acidic aqueous medium, at least 90% of the titanic acid in said solid dissolves. In a preferred embodiment the solid is mostly or totally dissolved.

According to a first forming embodiment said forming an aqueous precursor comprises contacting said solid with an acidic aqueous medium to form a first titanyl solution, contacting a salt selected from the group consisting of titanium salts, titanyl salts and combinations thereof with an acidic aqueous medium to form a second titanyl solution and contacting said second titanyl solution with said first titanyl solution.

According to a second forming embodiment said forming an aqueous precursor comprises contacting said solid titanic acid with an acidic aqueous medium to form a first titanyl solution, providing a salt selected from the group consisting of titanium salts, titanyl salts and a combinations thereof and contacting said salt with said first titanyl solution.

According to a third forming embodiment said forming an aqueous precursor comprises contacting a salt selected from the group consisting of titanium salts, titanyl salts and combinations thereof with an acidic aqueous medium to form a second titanyl solution, and contacting said second titanyl solution with said solid titanic acid.

According to an embodiment said forming comprises a combination of at least two of said first forming embodiment, said second forming embodiment and said thirs forming embodiment.

Any form of contacting said solid with an acidic aqueous medium is suitable. According to an embodiment, contacting comprises dispersing the solid in solution, mixing, agitation, shaking. In a preferred embodiment the resulting solid is post treated to remove any undissolved solids.

According to an embodiment, during said contacting, the temperature of said acidic aqueous medium is below 100° C., preferably below 90° C. and more preferably below 80° C. According to an embodiment, on contacting the temperature of said acidic medium drops to below 60° C.

According to an embodiment said formed aqueous precursor is a clear solution, i.e. essentially free of suspended solids.

According to an embodiment, on contacting said solid with an acidic aqueous medium, at least 75% of the titanic acid in it dissolves, preferably at least 90% and more preferably at least 99.9%.

Said contacting said solid with an acidic aqueous medium forms an aqueous precursor solution at given conditions of temperature, pH and concentration. According to a preferred embodiment, the temperature of said precursor solution is in the range between 0 ° C. and 70° C. According to a preferred embodiment, the titanium ions concentration in said precursor solution is in the range between 0.25 wt % and 15 wt % of solution.

The method of the present invention is characterized by the step of modifying at least one of said conditions of said aqueous precursor and maintaining said aqueous precursor at said modified conditions, whereupon precipitation of precipitate comprising small-size titanium oxide particles takes place, said modifying comprising at least one of temperature elevation and pH elevation.

According to an embodiment, the temperature of said aqueous precursor is elevated to at least 50° C., preferably at least 100° C. and more preferably at least 110° C. According to an embodiment, the modified temperature of said aqueous precursor is in the range between 50 and 110° C., preferably between 60° C. and 100° C. Any form of temperature elevation is suitable. According to another embodiment, the modified temperature of said aqueous precursor is in the range between 90 and 250° C., preferably between 100° C. and 160° C. Any form of temperature elevation is suitable. According to an embodiment, temperature elevation comprises flowing the solution in a plug flow mode through a heat exchanger. In another embodiment, the solution is heated in a vessel in a batch mode.

According to an embodiment, the pH of said aqueous precursor is elevated by at least 1 pH unit, According to another embodiment, the pH of said aqueous precursor is elevated to a pH lower than 5.

Any form of pH elevation is suitable, including addition of a base and removing an acid.

According to an embodiment, said maintaining said aqueous precursor at said modified conditions is for a residence time of at least 5 seconds, preferably at least 30 seconds. According to an alternative embodiment, at least one of said temperature, pH and concentration is changed during said maintaining. Thus, according to a related embodiment, the temperature of said aqueous precursor is elevated to a given temperature (modified temperature) at a given rate and then kept for a given time.

Formation of said precipitate comprising small-size titanium oxide particles may start, according to an embodiment, during said modifying. According to an embodiment, the majority of said precipitation takes place during said maintaining in said modified conditions.

According to an embodiment, said precipitation during said maintaining in said modified conditions is rapid. Thus, according to an embodiment, during maintaining at said modified conditions for 0.1-1 hour, precipitation yield is at least 75%, preferably at least −90%, and more preferably at least 95%. In another preferred embodiment, the change in the modified conditions is moderate and the modified solution retains in said conditions for a time longer than 0.5 hours and shorter than 1 day.

According to an embodiment, said aqueous precursor comprises (i) an acid having a pKa lower than 1 at a concentration of at least 2% wt, preferably at least 5 and more preferably at least 7 wt %; (ii) a titanyl salt selected from the group consisting of titanyl chloride, titanyl nitrate, organo-titanyl salts and combination thereof; and (iii) dissolved titanic acid. According to an embodiment, said acid is selected from the group consisting of halogenic acids, sulfuric acid, nitric acid, organic acids and combination thereof.

According to an embodiment, the concentration of said titanyl salt in said aqueous precursor is in the range between 0.25% and 15 wt %, preferably between 1 wt % and 10 wt %. According to a an embodiment, the weight ratio between the amount of titanium cation originated from said titanic acid in said solid and the amount of said titanium cation originated in the titanyl salt is in the range between 0.001 and 1.In a preferred embodiment the above ratio is in the range of between 0.001 to 0.5, more preferably in the range of 0.005 to 0.2. In another preferred embodiment between the above ratio is in the range of between 0.25 to 1, more preferably in the range of 0.5 to 1. According to another embodiment, the ratio between the number of equivalents of the anions of said acid and the number of equivalents of combined titanium compounds is greater than 2.5, preferably greater than 3 and more preferably greater than 4.

According to another embodiment, the ratio between the number of equivalents of the anions of said acid and the number of equivalents of combined titanium compounds is lower than 2.5, preferably lower than 2.2 and more preferably lower than 2 and higher than 1. According to another embodiment, the number of equivalents of anions includes all anions present in solution and having a pH lower than 1, reducing the equivalents of any cation other than titanium present in said solution.

As used herein, the term amount of titanic acid is intended to denote the amount of titanic acid in said provided solid. As used herein, the term amount of titanyl salt means the amount of titanyl salt in said aqueous precursor, essentially the amount of titanyl salt used to form it. As used herein, the term equivalents of the anions of said acid originated in the added acid and the added titanyl/titanium salt

As used herein, the term equivalents of combined titanium compounds is intended to denote the number of equivalent of titanyl salts and in said aqueous precursor, essentially the amount of titanyl salts used to form it combined with the equivalents of titanic acid in said provided solid.

According to an embodiment, said aqueous precursor comprises (i) an acid having a pKa lower than 1 at a concentration of at least 8% wt; (ii) a titanyl salt selected from the group consisting of titanyl chloride, titanyl nitrate, organo-titanyl salts and combination thereof; and (iii) dissolved titanic acid, the weight ratio between the amount of titanium in said titanic acid in said solid and the amount of said titanium cations in said titanyl salt being in the range between 0.001 and 0.5, the ratio between the number of equivalents of the anions of said acid and the number of equivalents of combined titanium compounds being greater than 3, the precipitate comprising crystals, and said crystals, being of crystal size (measured by X ray diffraction) in the range between 4 nm to 100 nm, preferably between 5 nm and 80 nm.

According to an embodiment, said aqueous precursor comprises (i) an acid having a pKa lower than 1 at a concentration of at least 4% wt; (ii) a titanyl salt selected from the group consisting of titanyl chloride, titanyl nitrate, organo-titanyl salts and combination thereof; and (iii) dissolved titanic acid, the weight ratio between the amount of titanium in said titanic acid in said solid and the amount of titanium in said titanyl salt being in the range between 0.001 and 0.5, the ratio between the number of equivalents of the anions of said acid and the number of equivalents of combined titanium compounds being greater than 3, the precipitate comprising crystals, and the majority of said crystals, preferably at least 75% and more preferably at least 95% and more preferably, practically all of the crystals having anatase crystal properties.

According to another embodiment, said aqueous precursor comprises (i) an acid having a pKa lower than 1; and (ii) dissolved titanic acid. According to an embodiment, said acid is selected from the group consisting of halogenic acids, sulfuric acid, nitric acid, organic acids and combination thereof.

According to another embodiment, the ratio between the number of equivalents of the anions of said acid and the number of equivalents of combined titanium compounds is less than 2.5, preferably less than 2.2 and more preferably less than 2. As used herein, the term equivalents of the anions of said acid means the number of equivalent of the anions of acids having a pK lower than 1 in said aqueous precursor, reducing the amount of cations other than titanium. As used herein, the term equivalents of combined titanium compounds means the number of equivalent of titanyl salts and in said aqueous precursor, essentially the amount of titanyl salts used to form it combined with the equivalents of titanic acid in said provided solid.

According to an embodiment, said aqueous precursor comprises (i) an acid having a pKa lower than 1; and (ii) dissolved titanic acid, the ratio between the number of equivalents of the anions of said acid and the number of equivalents of combined titanium compounds being less than 2.5, said precipitate comprising crystals, and the majority of said crystals preferably at least 75% and more preferably at least 90% and more preferably, practically all of the crystals having rutile crystal properties.

According to an embodiment the majority of the anions in said aqueous precursor, are chloride anions, wherein said precipitate comprises crystals, and wherein the majority of said crystals have anatase crystal properties

According to an embodiment, said precipitate comprises crystals of a given average crystal size of between 4 nm to 15 nm and said method further comprises a step of maintaining said precipitate, as such or after treatment, at a temperature of at least 120° C., preferably at least 140° C. and more preferably at least 160° C., for at least 0.5 hour preferably at least 2 hours and more preferably at least 6 hours, whereupon the average crystal size increases by at least 20%, preferably at least 30% and more preferably at least 50%.

According to an embodiment, said average crystal size prior to said maintaining at a temperature of at least 120° C., is in the range between 4 and 15 nm, preferably between 6 nm and 12 nm and most preferably between 8 nm and 11 nm. According to an embodiment, said maintaining at a temperature of at least 120° C. is conducted in a pressure vessel.

According to an embodiment, said maintaining at a temperature of at least 120° C. comprises maintaining in an aqueous solution comprising an acid at a concentration of at least 1% wt, preferably at least 10% wt and more preferably at least 20% wt.

According to an embodiment, said maintaining at a temperature of at least 120° C. comprises suspending in an aqueous solution of at least 1% wt HCl.

The present invention further provides small-size titanium oxide particles produced in a method comprising the steps of: (a) providing a solid comprising titanic acid; (b) contacting said solid with an acidic aqueous medium thereby forming an aqueous precursor solution at given conditions of temperature, pH and concentration; and (c) modifying at least one of said conditions of said aqueous precursor and maintaining said aqueous precursor at the modified conditions, whereupon precipitation of a precipitate comprising small-size titanium oxide particles takes place said modifications being selected from at least one of temperature elevation and pH elevation.

The present invention further provides a method for the production of nano titania inside a mesoporous matrix. In preferred embodiments said method comprises the steps of: (a) providing a solid containing titanic acid; (b) contacting said solid with an acidic aqueous medium thereby forming an aqueous precursor solution at a temperature lower than 100° C., pH higher than 0 and concentration of titanium higher than 0.25%; (c) infiltration of said solution into a mesoporous matrix and (d) inducing a change in conditions selected from a group of increasing the pH above pH=2 or increasing the temperature by at least 10° C. and maintaining said aqueous precursor described in (b) at the modified conditions, whereupon precipitation of a precipitate comprising small-size titanium oxide particles takes place inside said mesoporous matrix .

In a preferred embodiment the mesoporous matrix is selected from the group consisting of silica gel, glass, ceramic, glass ceramic, metal oxide, molecular sieve, polymers and combinations thereof.

In a preferred embodiment the method further comprises a step of drying the mesoporous matrix at elevated temperatures after the production of the titania.

In a preferred embodiment the method further comprises a step of applying vacuum to the mesoporous matrices before infiltration of the reaction solution into the pores.

In a preferred embodiment the product is transparent in the visible range.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### Example 1

Titanic acid was produced by adding ammonia solution to TiOCl₂ solution at 35° C., producing a precipitate at high temperature. The precipitate was cooled by immediate addition of D.I water to 40° C.

A solution containing 2 wt % Titanium, in which the titanium originating from the titanic acid is 10% of the total titanium, was prepared by mixing the wet titanic acid, titanyl chloride and 35% HCl solution at 25° C. The final HCl concentration in the solution was 13%.

100 liter of the above solution was flowed in a plug flow mode via a heat exchanger, at a rate of 2 lit/min, modifying the temperature of the exiting solution by 120° C. . Thus the final temperature in the solution exiting the heat exchanger was 160° C. The resulting suspension was cooled, filtered and washed with distilled water via a nano-filtration unit. A sample from the resulting solid was sent for analysis using XRD.

Result: The product particles were made of nano TiO2—anatase having mid crystal size of 8.4 nm.

### Example 2

Titanic acid was produced by adding ammonia solution to TiOCl₂ solution at 35° C., producing a precipitate at high temperature. The precipitate was cooled by immediate addition of D.I water to 40° C.

A solution containing 2 wt % Titanium, in which the titanium originating from the titanic acid is 5% of the total titanium, was prepared by mixing the wet titanic acid, titanyl chloride and 35% HCl solution at 255° C. The final HCl concentration in the solution was 13%.

100 liter of the above solution was flowed in a plug flow mode via an heat exchanger, at a rate of 2 lit/min, modifying the temperature of the exiting solution by 120° C. Thus the final temperature in the solution exiting the heat exchanger was 160° C. The resulting suspension was cooled, filtered and washed with distilled water via a nano-filtration unit. A sample from the resulting solid was sent for analysis using XRD.

Result: The product particles were made of nano TiO2—anatase having mid crystal size of 8.3 nm.

### Example 3

Titanic acid was produced by adding ammonia solution to TiOCl₂ solution at 35° C., producing a precipitate at high temperature. The precipitate was cooled by immediate addition of D.I water to 40° C.

A solution containing 2 wt % Titanium, in which the titanium originating from the titanic acid is 0.2% of the total titanium, was prepared by mixing the wet titanic acid, titanyl chloride and 35% HCl solution at 25° C. The final HCl concentration in the solution was 13%.

100 liter of the above solution was flowing in a plug flow mode via an heat exchanger, at a rate of 2 lit/min, modifying the temperature of the exiting solution by 120° C. Thus the final temperature in the solution exiting the heat exchanger was 160° C. The resulting suspension was cooled, filtered and washed with distilled water via a nano-filtration unit. A sample from the resulting solid was sent for analysis using XRD.

Result: The product particles were made of 71% nano TiO2—anatase having mid crystal size of 9.5 nm.

### Example 4

Titanic acid was produced by adding ammonia solution to TiOCl₂ solution at 35° C., producing a precipitate at high temperature. The precipitate was cooled by immediate addition of D.I water to 40° C.

A solution containing 6.3 wt % Titanium, in which the titanium originating from the titanic acid is 100% of the total titanium, was prepared by mixing the wet titanic acid, and 35% HCl solution at 25° C. The final HCl concentration in the solution was 12.92%.

1 liter of the above solution was heated, modifying the temperature of the solution by 35° C. Thus the final temperature was 60° C. A precipitate was observed. The resulting suspension was mixed for an additional 4 hours, filtered and washed with distilled water. A sample from the resulting solid was sent for analysis using XRD.

Result: The product particles were made of 100% nano TiO2—rutile having mid crystal size of 44.8 nm.

### Example 5

Titanic acid was produced by adding ammonia solution to TiOCl₂ solution at 35° C., producing a precipitate at high temperature. The precipitate was cooled by immediate addition of D.I water to 40° C.

A solution containing 7 wt % Titanium, in which the titanium originating from the titanic acid is 100% of the total titanium, was prepared by mixing the wet titanic acid, and 35% HCl solution at 30° C. The final HCl concentration in the solution was 10.4%.

1 liter of the above solution was heated 1 liter, modifying the temperature of the solution by 35° C. Thus the final temperature was 60° C. A precipitate was observed. The resulting suspension was mixed for an additional 4 hours, filtered and washed with distilled water. A sample from the resulting solid was sent for analysis using XRD.

Result: The product particles were made of 100% nano TiO2—rutile having mid crystal size of 53.6 nm.

### Example 6

Titanic acid was produced by adding ammonia solution to TiOCl₂ solution at 35° C., producing a precipitate at high temperature. The precipitate was cooled by immediate addition of D.I water to 40° C.

A solution containing 7 wt % Titanium, in which the titanium originating from the titanic acid is 100% of the total titanium, is prepared by mixing the wet titanic acid, 25% titanyl chloride solution and 35% HCl solution at 25° C. The final HCl concentration in the solution is 10.4%. 50% of the titanium is originated from the titanic acid precipitate

1 liter of the above solution is heated1liter of the above solution was heated, modifying the temperature of the solution by 35° C. Thus the final temperature was 60° C. The resulting suspension was mixed for an additional 2 hours, filtered and washed with distilled water. A sample from the resulting solid is sent for analysis using XRD.

Result: The product particles are made of 100% nano TiO2—rutile having mid crystal size of 50 nm.

### Example 7

Titanic acid was produced by adding ammonia solution to a TiOSO₄ solution to create a pH of 7.0, at 35° C., producing a precipitate at high temperature. The precipitate was cooled by immediate addition of D.I water to 40° C.

A solution containing 7 wt % Titanium, in which the titanium originating from the titanic acid is 100% of the total titanium, is prepared by mixing the wet titanic acid, sulfuric acid solution and water up to SO4/Ti equivalent ratio of 1.9. 100% of the titanium is originated from the titanic acid precipitate.
1. Porous glass was prepared by the following method:
a. Preparation and aging of Tetra ethyl ortho silicate (TEOS) solution.
b. pH adjustment using ion exchange resin
c. Drying up in petri dishes.

Components of solution: 33.2% TEOS—37.8% ETHANOL—29% WATER at pH=1.25.

Detailed description: TEOS was mixed with ethanol and water was added slowly, while keeping the temperature at 5-8° C. The solution was than heated to 60° C. for an hour and then left to cool down to room temperature.

Anion exchange resin (OH) form was added slowly until a pH of 4.8 was reached. The solution was poured into plates to form a 5 mm deep layer and left to dry for 24 hours. The product porous glass was broken into the required mesh size.

100 gr of Porous glass beads of mean pore size of 100 nm, particle size of 1 mm and density of 1.5 is introduced into a flask. A vacuum pump reduces the pressure to below 10 mmHg and 200 gr of the above solution was introduced into the flask under vacuum for 10 min. The particles were filtered, washed 3 times with DI water and introduced into a flask. The temperature was elevated by 75° C. For 2 hours.

A sample from the particles was tested for titania. The particles contained 6 wt % of anatase having crystal size of 9.5 nm.

### Example 8

Titanic acid is produced by adding ammonia solution to a TiOCl₂ solution at 35° C. producing a precipitate at high temperature. The precipitate is cooled by immediate addition of D.I water to 40° C.

A solution containing 7 wt % Titanium, in which the titanium originating from the titanic acid is 30% of the total titanium, is prepared by mixing the wet titanic acid, 25% titanyl chloride solution and 35% HCl solution at 25° C. The final Cl concentration in the solution is 13%. Citric acid was added to reach a concentration of 1%

1 liter of the above solution is heated, modifying the temperature of the solution by 40° C. Thus the final temperature was 65° C. The resulting suspension is mixed for additional 2 hours, filtered and washed with distilled water. A sample from the resulting solid is sent for analysis using XRD.

Result: The product particles are made of 100% nano TiO₂—anatase having mid crystal size of 5 nm and mid particle size of 18 nm. The suspension is highly transparent and highly stable

### Example 9

Titanic acid is produced by adding ammonia solution to a TiOCl₂ solution at 35° C., producing a precipitate at high temperature. The precipitate is cooled by immediate addition of D.I water to 40° C.

A solution containing 7 wt % Titanium, in which the titanium originating from the titanic acid is 30% of the total titanium, is prepared by mixing the wet titanic acid, 25% titanyl chloride solution and 35% HCl solution at 25° C. The final Cl concentration in the solution is 13%. Acetyl acetone is added to reach a concentration of 1%. Serine is added to reach a concentration of 1%

1 liter of the above solution is heated1liter of the above solution was heated, modifying the temperature of the solution by 40° C. Thus the final temperature was 65° C. The resulting suspension is mixed for an additional 2 hours, filtered and washed with distilled water. A sample from the resulting solid is sent

Result: The product particles are made of 100% nano TiO₂—anatase having mid crystal size of 6 nm and mid particle size of 22 nm. The suspension is highly stable.

It will be evident to those skilled in the art that the invention is not limited to the details of the foregoing illustrative examples and attached figures and that the present invention may be embodied in other specific forms without departing from the essential attributes thereof, and it is therefore desired that the present embodiments and figures be considered in all respects as illustrative and not restrictive, reference being made to the appended claims, rather than to the foregoing description, and all changes which come within the meaning and range

What is claimed is:

1. A method for the production of small-size titanium oxide particles, comprising the steps of:
a. providing a solid containing titanic acid;
b. contacting said solid with an acidic aqueous medium thereby forming an aqueous precursor solution at given conditions of temperature lower than 100° C., Titanium cation concentration lower than 20 wt % and higher than 0.1 wt %, pH lower than 1 and strong acid concentration higher than 2.5% and lower than 30%;
c. optionally, adding one or more capping agents to the aqueous precursor solutions; and
d. modifying at least one of said conditions of said aqueous precursor and maintaining said aqueous precursor at the modified conditions, whereupon precipitation of a precipitate comprising small-size titanium oxide particles takes place, said modifications being selected from at least one of temperature elevation by at least 5° C. and pH elevation by at least 0.1 pH units.

2. A method according to claim 1, wherein during contacting said solid with an acidic aqueous medium for 5 min, at least 95% of the titanic acid in said solid is dissolved.

3. A method according to claim 1, wherein the modified conditions are maintained for 0.1-1 hour and precipitation yield is at least 75%.

4. A method according to claim 1, wherein said acidic aqueous medium comprises at least one of a titanium salt, a titanyl salt and an acid having a pKa lower than 1.

5. A method according to claim 1, wherein said forming an aqueous precursor comprises at least one of:
(i) contacting said solid with an acidic aqueous medium to form a first titanyl solution, contacting a salt selected from the group consisting of titanium salts, titanyl salts and combinations thereof with an acidic aqueous medium to form a second titanyl solution and contacting said second titanyl solution with said first titanyl solution;
(ii) contacting said solid titanic acid with an acidic aqueous medium to form a first titanyl solution, providing a salt selected from the group consisting of titanium salts, titanyl salts and a combinations thereof and contacting said salt with said first titanyl solution, and
(iii) contacting a salt selected from the group consisting of titanium salts, titanyl salts and combinations thereof with an acidic aqueous medium to form a second titanyl solution, and contacting said second titanyl solution with said solid titanic acid.

6. A method according to claim 1, wherein said aqueous precursor is a clear solution.

7. A method according to claim 1, wherein said acidic aqueous medium comprises an acid selected from the group consisting of sulfuric acid, hydrochloric acid, nitric acid, organic acids of pKa lower than 1 and combinations thereof.

8. A method according to claim 1, wherein said acidic aqueous medium comprises at least one of titanyl chloride, titanyl sulfate, titanium chloride, titanium salts of organic acids and titanyl salts of organic acids.

9. A method according to claim 1 wherein said aqueous precursor comprises
(i) an acid having a pKa lower than 1 at a concentration of at least 10% wt;
(ii) a titanyl salt selected from the group consisting of titanyl chloride, titanyl nitrate, organo-titanyl salts and combination thereof; and
(iii) dissolved titanic acid;
wherein the weight ratio between the amount of said titanic acid in said solid and the amount of said titanyl salt is in the range between 0.001 and 0.5;
wherein the ratio between the number of equivalents of the anions of said acid and the number of equivalents of combined titanium compounds is greater than 3); and
wherein the precipitate comprises crystals, and wherein the majority of said crystals are of crystal size in the range between 5 nm to 15 nm.

10. A method according to claim 9 wherein said acid is selected from the group consisting of halogenic acids, sulfuric acid, nitric acid, organic acids and combination thereof.

11. A method according to claim 1 wherein said aqueous precursor comprises
(i) an acid having a pKa lower than 1 at a concentration of at least 10% wt;
(ii) a titanyl salt selected from the group consisting of titanyl chloride, titanyl nitrate, organo-titanyl salts and combination thereof; and
(iii) dissolved titanic acid;
wherein the weight ratio between the amount of said titanic acid in said solid and the amount of said titanyl salt is in the range between 0.001 and 0.5;
wherein the ratio between the number of equivalents of the anions of said acid and the number of equivalents of combined titanium compounds is greater than 3); and
wherein the said precipitate comprises crystals, and wherein the majority of said crystals have anatase crystal properties.

12. A method according to claim 11 wherein said acid is selected from the group consisting of halogenic acids, sulfuric acid, nitric acid, organic acids and combination thereof.

13. A method according to claim 1, wherein said aqueous precursor comprises
(i) an acid having a pKa lower than 1; and
(ii) dissolved titanic acid;
wherein the ratio between the number of equivalents of the anions of said acid and the number of equivalents of combined titanium compounds is less than 2.5 and
wherein said precipitate comprises crystals, and wherein the majority of said crystals have rutile crystal properties.

14. A method according to claim 13 wherein said acid is selected from the group consisting of halogenic acids, sulfuric acid, nitric acid, organic acids and combinations thereof.

15. A method according to claim 1, wherein the majority of the anions in said aqueous precursor are chloride anions, wherein said precipitate comprises crystals, and wherein the majority of said crystals have anatase crystal properties.

16. A method according to claim 1, wherein said precipitate comprises crystals of a given average crystal size, further comprising a step of maintaining said precipitate, as such or after treatment, at a temperature of at least 120° C. for at least 0.5 hour, whereupon the average crystal size increases by at least 20%.

17. A method according to claim 16 wherein said maintaining is in an aqueous solution comprising an acid at a concentration of at least 1% wt.

18. A method according to claim 16, wherein said maintaining comprises suspending in an aqueous solution of at least 10% HCl.

19. Small-size titanium oxide particles whenever produced according to the method of claim 1.

20. A method according to claim 1, wherein titania is produced inside a mesoporous matrix.

21. A method according to claim 20 comprising the steps of: (a) providing a solid containing titanic acid ; (b) contacting said solid with an acidic aqueous medium thereby forming an aqueous precursor solution at a temperature lower than 100° C., pH higher than 0 and concentration of titanium higher than 0.25%; (c) infiltration of said solution into a mesoporous matrix and (d) inducing a change in conditions selected from a group of increasing the pH above pH=2 or increasing the temperature by at least 10° C. and maintaining said aqueous precursor described in (b) at the modified conditions, whereupon precipitation of a precipitate comprising small-size titanium oxide particles takes place inside said mesoporous matrix.

22. A method according to claim 20 in which the mesoporous matrix is selected from the group consisting of silica gel, glass, ceramic, glass ceramic, metal oxide, molecular sieve, polymers and combinations thereof.

23. A method according to claim 21 further comprising a step of drying the mesoporous matrix at elevated temperatures after the production of the titania.

24. A method according to claim 21 which further comprises a step of applying vacuum to the mesoporous matrices before infiltration of the reaction solution into the pores.

25. A method according to claim 20 which the product is transparent in the visible range.

26. A method according to claim 1, wherein an additive selected from the group containing organic acids, hydroxyl organic acids, amines. Hydroxy-amines, amino acides, ketones, aldehides or alkanols and combination of the above is added into said aqueous precursor solution.

27. A method according to claim 26, wherein said additive is a hydroxy organic acid.

28. A method according to claim 26, wherein said additive is selected from the group consisting of an aldehyde or a ketone.

29. A method according to claims 1 and 26, wherein said aqueous precursor solution comprises:
(i) an acid having a pKa lower than 1 and
(ii) dissolved titanic acid;
wherein the ratio between the number of equivalents of the anions of said acid and the number of equivalents of combined titanium compounds is less than 2.5 and
wherein said precipitate comprises crystals, and wherein the majority of said crystals have anatase crystal properties.
